(19) United States
(12) Patent Application Publication
(10) Pub. No.: US 2004/0060877 A1
(43) Pub. Date: Apr. 1, 2004

(54) Apparatus for preventing backflow into an ozone generator

(76) Inventor: Stephen P. Kasten, Prescott, AZ (US)

Correspondence Address: C. Robert von Hellens, CAHILL, VON HELLENS & GLAZER P.L.C., Suite 155, 2141 E. Highland Avenue, Phoenix, AZ, 85016, US

(21) Appl. No.: 10/665,819

(22) Filed: Sep. 17, 2003

Related U.S. Application Data
(60) Provisional application No. 60/411,614, filed on Sep. 18, 2002.

(51) Int. Cl. C02F 1/78

(52) U.S. Cl. 210/760

(57) ABSTRACT

Apparatus for injecting ozone into the return line of a filtration system used in conjunction with a tank of water incorporates a check valve in a suction line for an ozone generator providing the ozone. Flow of water through the conduit providing ozone from the ozone generator is precluded by the check valve establishing a pressure environment within the conduit to prevent the flow of water from reaching the ozone generator. As the check valve is in an atmospheric environment, it is unlikely to deteriorate or be damaged by the air flowing therethrough into the ozone generator and its integrity is preserved.

### CROSS REFERENCE TO RELATED APPLICATIONS

The present application relates to subject matter described in and claims priority to a provisional application entitled “Ozone Generator Backflow Prevention”, assigned Serial No. 60/411,614 and assigned a filing date of Sep. 18, 2002 and describing an invention made by the present inventor.

### BACKGROUND OF THE INVENTION

An ozone generator provides ozone (O₃) as a gas to be used for various purposes. The ozone may be used as an oxidizing agent to oxidize organic materials. It is commonly used as a bactericide and as a viricide to be mixed with a liquid, to sterilize devices, and in other environments to help reduce spread of disease. Thus, it is used in various industries as an oxidizer, bactericide and/or viricide. Pools and spas are widely used in both public and private locations and do serve as a transmissive medium for various diseases and cause or exacerbate the spread of disease and/or infections to user's of pools and/or spas. Chlorine is a commonly used chemical for pools and spas to prevent the spread of disease. However, unless the chlorine level is meticulously maintained, especially during periods of high use or when the temperature of the water is raised by the environment or through use of heaters, its effectiveness is compromised.

To aid in preventing the spread of disease, particularly in pools and spas, an ozone generator may be incorporated to inject ozone into filtered water being returned to the pool or spa. The conduit conveying the ozone includes a check valve to prevent backflow of the pool water, which backflow will tend to destroy the apparatus generating the ozone. Unfortunately, the presence of ozone in and about the check valve creates nitric acid and various salts that may cause damage to the check valve or clog it. In either event, the check valve either becomes useless for its intended function or may prevent flow of ozone therethrough.

### SUMMARY OF THE INVENTION

An ozone generator provides ozone for injection into filtered water being returned to a pool or spa. The ozone generator includes a low pressure or suction line for drawing in air to be ozonated. A check valve is placed in the suction line to develop a closed gaseous environment to prevent outflow of water from the pool or spa to the ozone generator. Through such placement, the check valve tends to have a relatively long useful life as it is only subjected to a flow of air therethrough.

It is therefore a primary object of the present invention is to provide a check valve in an atmospheric environment and operating in conjunction with an ozone generator to ensure against drainage of water from a pool or spa therethrough.

Another object of the present invention is to provide a check valve and ozone generator used in conjunction with a pool or spa to prevent water drainage by not subjecting the check valve to the corrosive effects of ozone.

Still another object of the present invention is to provide a check valve for preventing drainage of water from a pool or spa that is in an environment which will ensure a long life of the check valve.

Yet another object of the present invention is to provide an ozone generator to inject ozone into a pool or spa and a check valve disposed upstream of the ozone generator for preventing drainage of water through the ozone generator.

A further object of the present invention is to provide an ozone generator for injecting ozone into a pool or spa which is downstream from a check valve and prevents drainage of water from the pool or spa.

A still further object of the present invention is to provide a method for injecting ozone into a pool or spa while preserving the integrity of a check valve preventing unwanted water drainage.

A yet further object of the present invention is to provide a check valve upstream of an ozone generator to prevent contact by the ozone generated with the check valve to preserve the integrity of the check valve.

These and other objects of the present invention will become apparent to those skilled in the art as the description there proceeds.

### BRIEF DESCRIPTION OF THE DRAWINGS

The present invention will be described with greater specificity and clarity with reference to the following drawings, in which:

FIG. 1 illustrates prior art apparatus for injecting ozone from an ozone generator into a pool or spa; and

FIG. 2 illustrates apparatus for eliminating an ozone enriched environment in proximity with a check valve used to prevent water drainage from a pool or spa.

### DESCRIPTION OF THE PREFERRED EMBODIMENT

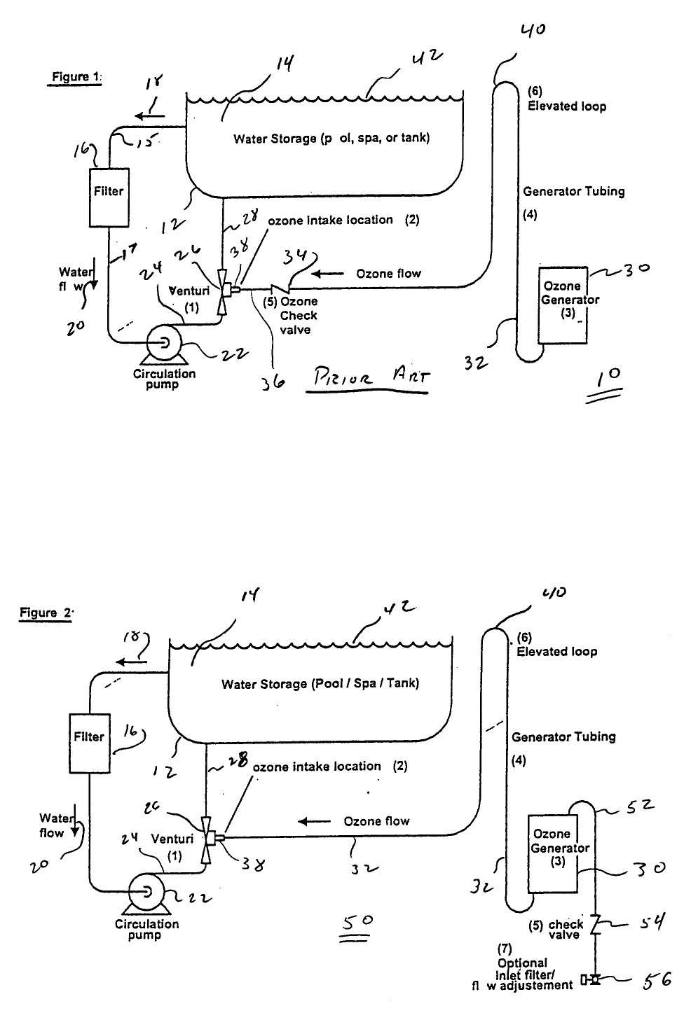

FIG. 1 illustrates a prior art system 10 for injecting ozone into a tank 12, which may be a pool, a spa, a water storage tank or other depository for water 14. A conventional filtration apparatus 16 filters water drawn from tank 12 through conduits 15, 17, as depicted by arrows 18, 20. The flow of water is urged and controlled by a circulation pump 22. The water outflow from the pump is through a conduit 24 to a venturi 26 and into the tank through a further conduit 28. An ozone generator 30, which may be any of many commercially available ozone generators, generates a flow of ozone conveyed by a conduit 32 through a check valve 34. A conduit 36 conveys the outflow from the check valve to inlet 38 of venturi 26. The flow of water from conduit 24 through the venturi creates a low pressure environment to draw the ozone from inlet 38 and entrain the ozone in the water exhausted from the venturi into conduit 28. Thereby, the water returned to tank 12 is ozone enriched. As is well known, the presence of ozone within tank 12 will serve in the manner of an oxidizer to break down organic material and it will serve in the manner of both a bactericide and a viricide to minimize contamination of water 14 by bacteria and viruses.

When circulation pump 24 is not operating, there may be a tendency for water to drain from tank 12 into conduit 28 and through venturi 26 into conduit 36. Check valve 34 prevents further drainage of the water through conduit 32 to protect ozone generator 30. Additionally, conduit 32 includes a loop section 40 having its highest point above level 42 of water 14. Thereby, force of gravity prevents any water within conduit 32 from flowing past loop 40. Thus, ozone generator 30 is protected against damage due to water flowing thereinto. Furthermore, loss of water from tank 12 is prevented.

One of the problems with prior art system 10 shown in FIG. 1 relates to check valve 34. Ozone flowing therethrough is an oxidizing agent and may cause damage to one or more components of the check valve due to oxidation. Additionally, the presence of ozone in the water at the upstream end of the check valve will produce nitric acid. This nitric acid will have a tendency to cause corrosion and other damage to one or more components of the check valve. Various salts may also be produced. Deposit of these salts on one or more components of the check valve may impact the operation of the check valve to the extent that it may no longer preclude waterflow therethrough. Alternatively, the check valve may become clogged and prevent further flow of ozone therethrough. These problems are experienced daily wherein prior art system 10 is installed. Sometimes loop 40 is not installed or is installed incorrectly, whereby it will no longer function as intended. Moreover, pressure waves within tank 12 may cause water to flow through the loop and thereafter it serves as a siphon to drain the water.

Referring to FIG. 2, a solution to the problems presented by prior art system 10 will be described. For the sake of clarity, elements common to prior art system 10 will be given the same reference numerals.

Apertures 50, forming the system shown in FIG. 2, is or may be identical to prior art system 10 with respect to tank 12, filter 16, pump 22 and the interconnecting conduits. A commercially available ozone generator 30 is adapted to include an inlet line or suction line 52 conveying air into the ozone generator. The ozone generated is exhausted into conduit 32, via loop 40 and into inlet 38 of a venturi 26. The purpose of the venturi is that of entraining ozone in the water flowing into tank 12 (typically a spa). Accordingly, the venturi shown in FIG. 2 could be replaced by a sparger or other device for entraining the ozone in the water flowing into the tank. A check valve 54 is mounted in suction line 52 to prevent backflow of air through the suction line. It is to be noted that suction line 52 downstream of check valve 54, ozone generator 30 and conduit 32 define a closed system having an inlet at the check valve and an outlet at inlet 32 of venturi 26. Check valve 54 is a commercially available check valve for limiting flow of a gas, air in the present case, only in one direction. In this case, air flows through check valve 54 only into suction line 52 and flow from the suction line through the check valve to the atmosphere is prevented by operation of the check valve. As this check valve is only subjected to an environment of air, it will not be subjected to the potential deterioration and damage to which check valve 34 in prior art system 10 is subjected. Check valve 54 operates in a relatively benign environment and it is well known to those skilled in the art how to construct check valves having a long operating life in such environments.

In the event circulation pump 22 ceases to operate and water 14 within tank 12 begins to drain through conduit 28, it may tend to flow into conduit 32 via venturi 26. As there is no airflow out of suction line 52 due to the operation of check valve 54, any water flowing into conduit 32 will be resisted by a commensurate pressure build up within the conduit. Thus, water flow into conduit 32 from inlet 38 of venturi 26 will only occur to a very limited extent until the respective pressures equalize. As discussed above, loop 40, being higher than water level 42 in tank 12 incorporates the force of gravity to prevent water flow past the loop. However, even in the absence of loop 40, the pressure build up within conduit 32 would prevent all but a minimal flow of water into conduit 32 and none of the water would reach ozone generator 30.

At some installations of spas, there may be a bubbling or “burping” by the ozone entrained in the water flowing thereinto. Such bubbling may be unpleasant or distracting to an occupant of the spa. To prevent such bubbling, a valve 55 may be placed upstream of check valve 54 to adjust the rate of airflow into the ozone generator and thereby control the rate of outflow of ozone from the ozone generator and into the spa. Additionally, valve 55 may incorporate one or more filter elements to filter the air flowing into suction line 52; alternatively, such a filter may be displaced from valve 55.

In conclusion, backflow of water to the ozone generator in apparatus 50 is primarily prevented by check valve 54 which creates a gaseous pressure environment within conduit 32. Additionally, as the check valve operates completely within an atmospheric environment, it is unlikely to deteriorate or be damaged by the air flowing therethrough and its proper operation for a long period of time can be expected. Thus, the present invention provides substantial benefits not present in nor available from prior art systems for introducing ozone into a tank of water.

I claim:

1. Apparatus for injecting ozone into a tank of water, said apparatus comprising in combination:
a) a filter for filtering the water drawn from said tank;
b) a venturi for entraining ozone in the filtered water flowing to the tank;
c) a circulation pump for drawing water through said filter and returning the water to said tank through said venturi to entrain ozone in the returning water;
d) an ozone generator for generating the ozone;
e) a conduit interconnecting said ozone generator and said venturi to convey ozone to said venturi from said ozone generator;
f) a suction line adapted to provide air to said ozone generator; and
g) a check valve disposed in said suction line to prevent airflow from said ozone generator through said check valve.

2. An apparatus as set forth in claim 1 wherein said venturi includes an inlet in fluid communication with said conduit.

3. An apparatus as set forth in claim 1 including a valve for metering airflow into said ozone generator.

4. An apparatus as set forth in claim 3 wherein said valve is upstream of said check valve.

5. An apparatus as set forth in claim 1 including a filter for filtering the air flowing into said ozone generator.

6. An apparatus as set forth in claim 5 wherein said filter is upstream of said check valve.

7. A method for injecting ozone into a tank of water, said method comprising the steps of:
a) filtering the water from the tank with a filter;
b) drawing the water through the filter and discharging the water into the tank through a device for entraining the ozone;
c) generating ozone with an ozone generator and conveying the ozone to the entraining device;
d) entraining the ozone conveyed in the water flowing into the tank;
e) further drawing air into the ozone generator through a suction line; and
f) precluding outflow of air from the suction line to restrain flow of water from the venturi to the ozone generator.

8. The method as set forth in claim 7 including the step of controlling the rate of flow of air into the ozone generator.

9. The method as set forth in claim 7 including the step of filtering the flow of air to the ozone generator.

10. The method as set forth in claim 8 including the step of filtering the flow of air to the ozone generator.

11. A method for preventing a flow of water from a tank to an ozone generator having a suction line for inflow of air and adapted to provide ozone for entrainment in water flowing into the tank, said method comprising the steps of:
a) conveying ozone through a conduit from the ozone generator;
b) entraining ozone from the conduit in the water flowing to the tank; and
c) preventing flow of air and ozone from the ozone generator through the suction line with a check valve disposed in the suction line.

12. The method as set forth in claim 11 including the step of controlling the rate of air flow into the ozone generator.

13. The method as set forth in claim 11 including the step of filtering the air flow to the ozone generator.

14. The method as set forth in claim 12 including the step of filtering the air flow to the ozone generator.

15. Apparatus for preventing a flow of water from a tank to an ozone generator adapted to provide ozone for entrainment in water flowing into the tank, said apparatus comprising in combination:
a) said ozone generator;
b) a device for entraining the ozone from said ozone generator in the water flowing into the tank;
c) a conduit for conveying ozone from said ozone generator to said device;
d) a suction line for providing air to said ozone generator; and
e) a check valve disposed in said suction line for establishing a pressurized environment in said conduit to prevent a flow of water therein to said ozone generator.

16. An apparatus as set forth in claim 15 including a valve for regulating the rate of flow of air into said suction line.

17. An apparatus as set forth in claim 15 including a filter for filtering the air flowing into said suction line.

18. An apparatus as set forth in claim 16 including a filter for filtering the air flowing into said suction line.

19. An apparatus as set forth in claim 15 wherein said device is a venturi.

20. An apparatus as set forth in claim 19 wherein said conduit includes a loop disposed above the level of the water in the tank.
